(19) United States
(12) Patent Application Publication
(10) Pub. No.: US 2025/0245480 A1
(43) Pub. Date: Jul. 31, 2025

(54) METHOD AND SYSTEM FOR PROVIDING A SECOND NEURAL NETWORK

(71) Applicant: Siemens Healthineers AG, Forchheim (DE)

(72) Inventors: Varghese KOLLERATHU, Bengaluru (IN); Vineet VINAY BHOMBORE, Bengaluru (IN); Matthias WOLF, Coatesville, PA (US)

(73) Assignee: Siemens Healthineers AG, Forchheim (DE)

(21) Appl. No.: 19/036,151

(22) Filed: Jan. 24, 2025

(30) Foreign Application Priority Data
Jan. 26, 2024 (EP) 24154149.9

(51) Int. Cl. G06N 3/045

(52) U.S. Cl. CPC G06N 3/045

(57) ABSTRACT

A computer-implemented method comprises: receiving a first neural network trained to map first input data to first output data; receiving a second neural network configured to map second input data to second output data, the second input data having a same structure as the first input data; determining a joint neural network including a first part of the first neural network and a second part of the second neural network; receiving first and second training data; training the joint neural network based on the first training data; training the second neural network based on the second training data and a second loss function, the second loss function including a layer loss function based on a comparison of values of a second layer of the second part in the second neural network and values of a corresponding layer in the trained joint neural network; and providing the second neural network.

### CROSS-REFERENCE TO RELATED APPLICATION(S)

The present application claims priority under 35 U.S.C. § 119 to European Patent Application No. 24154149.9, filed Jan. 26, 2024, the entire contents of which is incorporated herein by reference.

### FIELD

One or more embodiments of the present invention pertain to the domain of artificial intelligence (an acronym is “AI”), in particular, to a method for facilitating knowledge transfer from one AI model to another. This is particularly relevant in scenarios where the models have significantly different architectures and the original training data is restricted or unavailable due to technical constraints.

### BACKGROUND

In the dynamic field of AI, the development and training of advanced models are essential for ongoing progress. The data used to train these AI models is a critical factor in enhancing their performance. However, access to such data can often be restricted due to a variety of technical factors. These include stringent data privacy regulations that prevent the sharing of sensitive information, routine data purging practices at data sources like hospitals that erase historical data, and the use of decentralized training methods across multiple sites that limit centralized data access.

### SUMMARY

A challenge one or more embodiments of the present invention addresses is the transfer of knowledge from an established first neural network, trained in a decentralized environment or where access to training data is no longer available due to these technical constraints, to a new second neural network that has a different architecture from the first neural network.

The current approach, which involves directly using the data the first neural network was trained on, presents several limitations. Firstly, it is not feasible due to the technical constraints posed by data privacy regulations and the routine purging of data at source locations. Secondly, it lacks scalability as it is time-consuming and technically challenging to gather data from multiple sites spread across various geographical locations. Moreover, data privacy regulations often prevent the sharing of data, further complicating the process. Lastly, it is not cost-effective. A model trained in a decentralized manner over several years may have been trained on a large number of data points. Managing and storing these datasets at a central location can be prohibitively expensive, especially if the model was trained on a private dataset with limited access.

An underlying problem of one or more embodiments of the present invention is transferring knowledge from a first neural network to a second neural network without having access to the complete training data of the first neural network, overcoming the technical challenges associated with data access, privacy, and differences in model architecture. By solving this problem, one or more embodiments of the present invention might have the potential to significantly transform the way AI models learn and evolve, especially in decentralized environments where data privacy and access are critical considerations.

At least the aforementioned problem is solved according to the independent claims. Further advantageous embodiments and additional advantageous features are described in the dependent claims and in the specification.

In the following, a solution according to one or more embodiments of the present invention is described with respect to the claimed systems as well as with respect to the claimed methods. Features, advantages or alternative embodiments herein can be assigned to the other corresponding claimed objects and vice versa. In other words, the systems can be improved with features described or claimed in the context of the corresponding method. In this case, the functional features of the methods are embodied by objective units of the systems.

Furthermore, in the following, a solution according to one or more embodiments of the present invention is described with respect to methods and systems for providing a second neural network as well as with respect to methods and systems for using such a second neural network. Features, advantages or alternative embodiments herein can be assigned to the other claimed objects and vice versa. In other words, claims and embodiments for providing the second neural network can be improved with features described or claimed in the context of using the second neural network.

In the following, the term “in particular” is used to indicate an optional and/or advantageous additional feature. Furthermore, the terms “applying a neural network to data” or “applying a unit to data” is used to indicate that the respective data is used as input data for the model or the unit, or that input data is used that comprises the respective data (and potentially other data).

An embodiment of the present invention relates, in a first aspect, to a computer-implemented method for providing a second neural network. The method is based on receiving a first neural network trained to map first input data to first output data, and on receiving the second neural network configured to map second input data to second output data. The second input data has the same structure as the first input data. The method is furthermore based on determining a joint neural network comprising a first part of the first neural network and a second part of the second neural network. The method is furthermore based on receiving first training data and second training data. The method is furthermore based on training the joint neural network based on the first training data, and on training the second neural network based on the second training data and a layer loss function. The layer loss function is based on a comparison of values of a second layer of the second part in the second neural network and values of a corresponding layer in the trained joint neural network. Furthermore, the method is based on providing the second neural network.

In an alternative formulation, according to this aspect, an embodiment of the present invention relates to a computer-implemented method for providing a second neural network. The method is based on receiving a first neural network and on receiving the second neural network, wherein the input layer of the first neural network has the same size as the input layer of the second neural network. The method is furthermore based on determining a joint neural network comprising a first part of the first neural network and a second part of the second neural network. The method is furthermore based on receiving first training data and second training data. The method is furthermore based on training the joint neural network based on the first training data, and on training the second neural network based on the second training data and a layer loss function. The layer loss function is based on a comparison of values of a second layer of the second part in the second neural network and values of a corresponding layer in the trained joint neural network. Furthermore, the method is based on providing the second neural network.

In particular, the steps of receiving the first neural network and the second neural network, as well as the step of receiving the first training data and second training data are executed by an input unit or an interface, in particular, by an input unit or an interface of a providing system. In particular, the steps of determining the joint neural network as well as training the joint neural network and the second neural network are executed by a computation unit, in particular, by a computation unit of the providing system. In particular, the step of providing the second neural network is executed by an output unit or the interface, in particular, by an input unit or the interface of the providing system.

In particular, a neural network is a certain type of machine learning model. In particular, a machine learning model is a computational model that improves its performance at a task over time through exposure to data. This model can be a set of instructions or algorithms that generate a specific output from input data. More specifically, the machine learning model could be a supervised model, where the model is trained on a dataset with known outputs, or an unsupervised model, where the model identifies patterns in a dataset without known outputs.

In particular, a neural network may comprise nodes or layers of nodes (in this context, a synonym for “node” is “unit” or “processing element”) that are connected by edges, wherein weights are assigned to these edges. In particular, a neural network can be a deep neural network, a convolutional neural network, a convolutional deep neural network or a transformer network. Furthermore, a neural network can be an adversarial network, a deep adversarial network and/or a generative adversarial network.

In particular, the first input data and the second input data have the same structure implies that the first input data and the second input data have the same format, organization and/or representation.

In particular, if the first input data can be represented as a numerical vector or matrix, the second input data is a numerical vector or matrix of the same dimension. In particular, if the first input data is an image, the second input data is an image of the same dimension and the same size with respect to every dimension (measured in pixel or voxels).

In particular, the first neural network and the second neural network are configured to work on first input data and second input data having the same structure if the input layer of the first neural network and the input layer of the second neural network have the same size. In particular, the input layer of the first neural network and the input layer of the second neural network have the same size if the number of nodes within the input layer of the first neural network equals the number of nodes within the input layer of the second neural network.

Preferably, the first training data has the same structure as the first input data. Preferably, the second training data comprises data having the same structure as the second input data.

In particular, the first training data can comprise training data that has previously been used for training the first neural network. In particular, the first training data can be a subset of the training data used for training the first neural network. However, the first training data can also be independent of the training data that has previously been used for training the first neural network.

In particular, the second training data can comprise training data that has previously been used for training the first neural network. In particular, the second training data can be a subset of the training data used for training the first neural network. However, the second training data can also be independent of the training data that has previously been used for training the first neural network.

The joint neural network comprises a first part of the first neural network and a second part of the second neural network. In particular, a part of a neural network comprises layers of the neural network. Furthermore, a part of a neural network can comprise edges between nodes in the layers. In particular, a part of a neural network comprises a plurality of subsequent layers of a neural network, and all of the edges between the respective layers of the neural network.

In particular, the joint neural network is constructed to comprise a first part of the first neural network and a second part of the second neural network. This implies that weights of the edges within the joint neural network correspond to weights of the edges in the first part of the first neural network and the second part of the second neural network at the time of construction of the joint neural network. However, if subsequently there is a training of the joint neural network these weights of the edges can change based on the training of the neural network.

In particular, the joint neural network can be a foundation neural network. In particular, a foundation neural network is trained on a vast quantity of data at scale (in particular, by self-supervised learning or semi-supervised learning) such that it can be adapted to a wide range of downstream tasks.

In general, parameters of a machine learning model (in particular, of a neural network) can be adapted via training. In the process of training, the value of the weights associated to the edges is changed. In particular, supervised training, semi-supervised training, unsupervised training, reinforcement learning and/or active learning can be used. Furthermore, representation learning (an alternative term is “feature learning”) can be used. In particular, the parameters of the machine learning models can be adapted iteratively by several steps of training. In particular, within the training a certain cost function can be minimized. In particular, within the training of a neural network the backpropagation algorithm can be used.

In particular, a loss function is an operation that quantifies the difference between the predicted output and the actual output in a machine learning model or a neural network. Here, the predicted and the actual output of the neural network can also correspond to quantities that can be derived from parts of the neural network that do not correspond to the output layer of the neural network. The loss function can be used during the training of a neural network to adjust the weights and biases of the network. In particular, the goal of this adjustment process is to minimize the value of the loss function, thereby reducing the difference between the predicted and actual outputs and improving the performance of the model or neural network.

The inventors recognized that by using the first part of the first neural network in the joint neural network, the data incorporated into the first neural network by training can be transferred to the joint neural network. Furthermore, the training of the joint neural network can be executed in a self-supervised fashion, so that it is not necessary to acquire ground truth for the training data and there is a larger amount of available training data. Based on the usage of the layer loss function, the data incorporated in the joint network can be utilized in the training of the second neural network. This finally implies that for training the second neural network less training data is necessary compared to a training from scratch. In particular, in cases where not all training data of the first neural network is accessible anymore, using the proposed method the not available training data can still positively influence the training and the performance of the second neural network.

According to a further possible aspect, the first part comprises a first layer of the first neural network and/or the second part comprises a second layer of the second neural network. According to a further possible aspect, the first part comprises plurality of first layers of the first neural network and/or the second part comprises a plurality of second layer of the second neural network. The inventors recognized that by using a first part and/or a second part comprising full layers it can be exploited that that information in connected and corresponding parts of the neural networks is more relevant for the training of the second neural network.

According to a further aspect, the second part comprises a plurality of consecutive second layers of the second neural network. According to a further possible aspect, the first part comprises a plurality of consecutive first layers of the first neural network. The inventors recognized that by using a first part and/or a second part comprising full layers it can be exploited that that information in connected and corresponding parts of the neural networks is more relevant for the training of the second neural network.

According to a further aspect, the joint neural network comprises a mirrored second part being a mirrored version of the second part, wherein the last layer of the second part and the first layer of the mirrored second part are identical.

In general, a mirrored part being a mirrored version of an original part of a neural network may be understood to refer to an object that has a structure and configuration that is a reflection or inverse of the original part of the neural network. This mirrored part may have the same number of layers as the original part, but the order of the layers may be reversed. For example, if the original part consists of three consecutive layers in the order “layer A”, “layer B” and “layer C”, the mirrored part may consist of the same series of hidden layers in reverse order, i.e., three consecutive layers in the order “layer C”, “layer B” and “layer A”. In particular, the edges or weights of the original part can also be mirrored or inversed to determine the edges and weights of the mirrored part. In particular, if there is an edge between a first node of a first layer and a second node in the second layer of the original part, there is also a connection between the corresponding nodes and the corresponding layers of the mirrored part. The weights of the edges could be initialized randomly or calculated from the weights of the original part.

The inventor recognized that by using a mirrored second part within the joint neural network it is better suited for being trained in a self-supervised way.

According to a further aspect, the first part comprises a plurality of consecutive first layers of the first neural network and the joint neural network comprises a mirrored first part being a mirrored version of the first part. Furthermore, in the joint neural network the first part is arranged before the second part and the mirrored first part is arranged after the mirrored second part.

In particular, a first part of a neural network being arranged before a second part of a neural network means that the first part of the neural network is located nearer to the input layer of the neural network (and farer away from the output layer of the neural network) than the second part. Vice versa, a first part of a neural network being arranged after a second part of a neural network means that the first part of the neural network is located farer away from the input layer of the neural network (and nearer to the output layer of the neural network) than the second part.

The inventors recognized that by the joint neural network comprising the first and the second part as well as the mirrored first and the mirrored second part in the explained order it is possible to have a very efficient training of the joint neural network.

According to a further possible aspect, the joint neural network does not comprise an additional layer between the first part and the second part, and the joint neural network does not comprise an additional layer between the mirrored second part and the mirrored first part.

The inventors recognized that by not using additional layers between the first part and the second part and between the mirrored second part and the first part the number of additional weights that need to be adapted during training is minimal, improving the efficiency of the training of the joint neural network.

According to a further aspect, the layer loss function is based on cosine similarity, L1 loss and/or L2 loss of the second layer of the second part in the second neural network and the corresponding layer in the trained joint neural network.

In particular, the values of the second layer of the second part in the second neural network used corresponds to the set of values of the nodes of the second layer when the second neural network is applied to a certain element of training data. In particular, the values of the corresponding layer within the joint neural network corresponds to the values of the nodes of this layer when the joint neural network is applied to corresponding training data.

In particular, the values of the nodes of a layer can be arranged as a vector for calculating the loss function. In particular, it is possible to not use all of the nodes in the respective layers for constructing the vector to calculate the loss function. In particular, it would be possible to use corresponding subsets (comprising at least one node) of the nodes in the respective layers.

In particular, a cosine similarity may be understood to refer to a measure of similarity between two non-zero vectors of an inner product space, wherein the first vector corresponds to the values of the second layer within the second part in the second neural network, and the second vector corresponds to the values of the corresponding layer in the trained joint neural network. This measure is calculated by dividing the dot product of the two vectors by the product of the magnitudes of the vectors.

In particular, a L1 loss is a type of loss function that calculates the absolute differences between the true values and the predicted values. If the true values and the predicted values correspond to vectors, the loss function can be calculated by adding the element-wise absolute difference. The term “Least Absolute Deviations” can be used as a synonym for the term “L1 loss”.

In particular, a L2 loss is a type of loss function that calculates the square of the differences between the true values and the predicted values. If the true values and the predicted values correspond to vectors, the loss function can be calculated by adding the element-wise square of the differences. The term “Least Squares Error” can be used as a synonym for the term “L2 loss”.

The inventors recognized that using the cosine similarity, the L1 loss and/or the L2 loss is a very efficient way to minimize differences between a first vector and a second vector in a loss function, and creates a very efficient training process.

According to a further aspect, the second training data comprises training input data and associated training reference data, wherein the second loss function comprises an output loss function based on the comparison of the result of applying the second neural network to the training input data and the associated training reference data. In particular, the second training data can comprise a plurality of pairs, each pair comprising training input data and associated training reference data. In particular, the second loss function is chosen to minimize differences between the result of applying the second neural network to the training input data and the associated training reference data. In particular, the second loss function can correspond to a cosine-similarity, to an L1 loss, to an L2 loss and/or to a cross-entropy.

Preferably, the training input data has the same structure as the second input data.

The inventors recognized that based on the proposed output loss function it is possible to train the second neural network to reproduce the relationship between the training input data and the associated training reference data.

According to a further aspect of an embodiment of the present invention, the joint neural network comprises an input layer and an output layer, wherein the input layer of the joint neural network and the output layer of the joint neural network have equal size.

The inventors recognized that by having input and output layer of the same size the joint neural network has an autoencoder structure that can be trained unsupervised without creating a specific ground truth.

According to a further aspect, training the joint neural network is based on the difference of input data of the joint neural network and the output of the joint neural network when applied to the input data, wherein the input data is based on the first training data. In particular, the input data can be identical to the first training data.

The inventors recognized that by having a training based on the difference of input data and the corresponding output data, the joint neural network has an autoencoder structure that can be trained unsupervised without creating a specific ground truth.

According to a further aspect of an embodiment of the present invention, training the joint neural network comprises a sub-step of preprocessing the first training data with a preprocessing part of the first neural network, and a sub-step of applying the joint neural network to input data comprising the preprocessed first training data.

In particular, the preprocessing part comprises at least one layer of the first neural network. In particular, the preprocessing part can comprise at least two consecutive layers of the first neural network. In particular, the preprocessing part can comprise the input layer of the first neural network.

The inventors recognized that by preprocessing the first training data with a preprocessing part the structure of the joint neural network can be chosen more flexible and/or it is not necessary to use other methods of preprocessing the data if the joint neural network shall work with input data having a different structure than the input data of the first neural network.

According to a further aspect of an embodiment of the present invention, the preprocessing part and the first part consist of consecutive first layers of the first neural network, wherein the last layer of the preprocessing part is the first layer of the first part. In particular, the last layer of the preprocessing part within the first neural network is the first layer of the first part within the first neural network.

The inventors recognized that by using a preprocessing part and a first part that overlaps no additional transformation of data is necessary, due to the fact that the structure of the output data of the preprocessing parts equals the structure of the input data of the first part and/or the input data of the joint neural network.

According to a further aspect of an embodiment of the present invention, the method furthermore comprises augmenting the first training data and/or the second training data.

In particular, augmenting training data corresponds to the process of artificially expanding or enhancing the training data to improve the performance of a machine learning model and, in particular, a neural network. This process may involve creating new data points based on the existing data, which may include, but is not limited to, techniques such as perturbation, rotation, scaling, flipping, cropping, or any other type of transformation known in the art. In particular, augmenting the training data may involve perturbing the existing data by adding a small amount of noise to create new data points. Alternatively, augmenting training data may involve rotating or flipping images in a dataset used for training an image recognition model.

The inventor recognized that data augmentation can increase the diversity and amount of training data, which can help the model generalize better and reduce overfitting, leading to improved performance on unseen data. Furthermore, data augmentation is a cost-effective way to increase the size and diversity of the training data without the need for collecting new data, which can be expensive and time-consuming. Additionally, data augmentation can help the model learn features that are invariant to the transformations used in the augmentation process, leading to a better representation of the data.

Embodiments of the present invention relate, in a second aspect, to a computer-implemented method, comprising the step of using a second neural network provided by a method according to an aspect of embodiments of the present invention for at least one of controlling a medical imaging apparatus and/or a laboratory apparatus, processing a medical image of a patient, digital audio enhancement, image enhancement and/or video enhancement, digital audio analysis, image analysis and/or video analysis, encrypting, decrypting and/or signing electronic communications, speech recognition, providing a medical diagnosis by an automated system processing physiological measurements, processing a medical image of a patient to segment and/or classify a structure within the medical image.

For the task of controlling a medical imaging apparatus and/or a laboratory apparatus, neural networks can be used to optimize and streamline imaging protocols by reducing the time spent acquiring image data, or it can be used to improve resolution and enhance image quality. In particular, one can use models such as a super-resolution convolutional neural network model, a denoising convolutional neural network model, or a perceptron neural network model in the medical imaging system.

For the task of digital audio, image and/or video enhancement, neural networks can be used to enhance the quality of digital audio, image, and video by reducing noise, improving resolution, and enhancing overall quality. In particular, one can use convolutional neural networks that can learn and understand the underlying patterns in the data.

For the task of digital audio, image and/or video analysis, neural networks can be used to analyze digital audio, image, and video data by identifying patterns, classifying data, and making predictions based on the learned patterns. In particular, one can use deep learning models that can learn complex representations of the data.

For the task of encrypting, decrypting and/or signing electronic communications, neural networks can be used to encrypt, decrypt, and sign electronic communications by learning the underlying patterns in the data and using these patterns to encode and decode the data. In particular, one can use recurrent neural networks that can learn sequences in the data.

For the task of speech recognition, neural networks can be used for speech recognition by converting spoken language into written text. In particular, one can use recurrent neural networks and long short-term memory (LSTM) networks that can learn the temporal dynamics of speech.

For the task of providing a medical diagnosis by an automated system processing physiological measurements, neural networks can be used to provide a medical diagnosis by processing physiological measurements and making predictions based on the learned patterns. In particular, one can use deep learning models that can learn complex representations of the data.

For the task of processing a medical image of a patient to segment and/or classify a structure within the medical mage, neural networks can be used to segment and classify structures within a medical image by learning the underlying patterns in the image data. In particular, one can use convolutional neural networks that can learn spatial hierarchies in the data.

Embodiments of the present invention relate, in a third aspect, to providing a system comprising means, an apparatus, device, or the like, for carrying out the method of one of the aspects of embodiments of the present invention.

Embodiments of the present invention relate, in a further aspect, to a system for providing a trained second neural network comprising at least one processor, the processor being configured for:
receiving a first neural network trained to map first input data to first output data,
receiving the second neural network configured to map second input data to second output data, wherein the second input data has the same structure as the first input data,
determining a joint neural network comprising a first part of the first neural network and a second part of the second neural network,
receiving first training data and second training data,
training the joint neural network based on the first training data,
training the second neural network based on the second training data and a second loss function, wherein the second loss function comprises a layer loss function based on a comparison of values of a second layer of the second part in the second neural network and values of a corresponding layer in the trained joint neural network,
providing (PROV) the second neural network.

Embodiments of the present invention relate, in a further aspect, to a system for using a second neural network provided by a method according to an aspect of embodiments of the present invention for at least one of
controlling a medical imaging apparatus and/or a laboratory apparatus,
processing a medical image of a patient,
digital audio enhancement, image enhancement and/or video enhancement,
digital audio analysis, image analysis and/or video analysis,
encrypting, decrypting and/or signing electronic communications,
speech recognition,
providing a medical diagnosis by an automated system processing physiological measurements,
processing a medical image of a patient to segment and/or classify a structure within the medical image.

Embodiments of the present invention relate, in a fourth aspect, to a non-transitory computer program product comprising instructions which, when the program is executed by a computer, cause the computer to carry out the method of one of the aspects of embodiments of the present invention.

Embodiments of the present invention relate, in a fifth aspect, to a non-transitory computer-readable storage medium comprising instructions which, when executed by a computer, cause the computer to carry out the method of one of the aspects of embodiments of the present invention.

The realization of embodiments of the present invention or one of its aspects by a non-transitory computer program product and/or a non-transitory computer-readable medium has the advantage that already existing systems can be easily adapted by software updates in order to work as proposed by one or more embodiments of the present invention.

The said computer program products can be, for example, a computer program or comprise another element apart from the computer program. This other element can be hardware, for example a memory device, on which the computer program is stored, a hardware key for using the computer program and the like, and/or software, for example a documentation or a software key for using the computer program.

### BRIEF DESCRIPTION OF THE DRAWINGS

The properties, features and advantages of this invention described above, as well as the manner they are achieved, become clearer and more understandable in the light of the following description and embodiments, which will be described in detail in the context of the drawings. This following description does not limit the present invention on the contained embodiments. Same components or parts can be labeled with the same reference signs in different figures. In general, the figures are not for scale.

The numbering and/or order of method steps is intended to facilitate understanding and should not be construed, unless explicitly stated otherwise, or implicitly clear, to mean that the designated steps have to be performed according to the numbering of their reference signs and/or their order within the figures. In particular, several or even all of the method steps may be performed simultaneously, in an overlapping way or sequentially.

In the following:

FIG. 1 displays a first embodiment of a first neural network,

FIG. 2 displays a first embodiment of a second neural network,

FIG. 3 displays a first embodiment of a joint neural network,

FIG. 4 displays a first embodiment of the training of a second neural network based on the pre-trained joint neural network,

FIG. 5 displays a second embodiment of a first neural network,

FIG. 6 displays a second embodiment of a second neural network,

FIG. 7 displays a second embodiment of a joint neural network,

FIG. 8 displays a second embodiment of the training of a second neural network based on the pre-trained joint neural network,

FIG. 9 displays a flowchart of a first embodiment of a method for providing a trained second neural network,

FIG. 10 displays a flowchart of a second embodiment of a method for providing a trained second neural network,

FIG. 11 displays an embodiment of a providing system.

### DETAILED DESCRIPTION

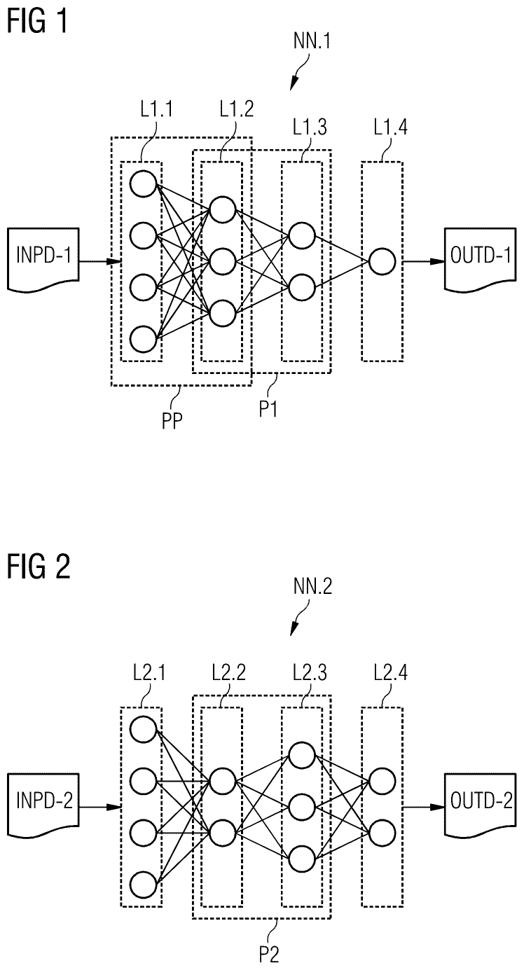

FIG. 1 displays an embodiment of a first neural network NN.1. The first neural network NN.1 takes first input data INPD.1 and is configured by training to map the first input data INPD.1 to first output data OUTD.1.

The first neural network NN.1 consists of four layers L1.1, . . . , L1.4 (an input layer L1.1, an output layer L1.4 and two hidden layers L1.2, L1.3). In this embodiment, the four layers L1.1, . . . , L1.4 are consecutive layers. Each of the layers L1.1, . . . , L1.4 comprises at least one node. Nodes of consecutive layers L1.1, . . . , L1.4 are connected by edges, and there is a weight (being a real number, preferably between −1 and 1) assigned to each of the edges. In this embodiment, between every pair of nodes in two consecutive layers there is an edge between these nodes (fully connected layers). Alternatively, it is also possible that there are only edges between selected pairs of nodes.

In this embodiment, the first input data INPD.1 is a four-dimensional vector of real numbers, and the first output data OUTD.1 is a real number (that can be interpreted as a one-dimensional vector of real numbers).

In the following, let xi(k) denote the value of the i-th node in the k-th layer L1.1, . . . , L1.4. In this notation, the first input data INPD.1 corresponds to the values xi(1), and the first output data OUTD.1 corresponds to the values xi(4). Values of a layer xj(k+1) are calculated based on the values of the previous layer xi(k) by xj(k+1)=f(k+1) (ΣjVij(k,k+1)xi(k)), wherein Vij(k,k+1) denotes the weight of the edge between node i in the k-th layer and node j in the (k+1)-th layer, and wherein f(k+1): [symbol] → [symbol] or f(k+1): [symbol] →[0, 1] is an activation function (e.g., sigmoid, tanh, ReLU or SoftMax function). The values of the weights can be structured as a matrix, and the values of the nodes can be structured as a vector, so that the calculation is equivalent to x(k+1)=f(k+1) (V(k,k+1)x(k)), wherein the activation function is applied component-wise to its argument.

In this embodiment, the first neural network NN.1 comprises a first part P1, which consists of the hidden layers L1.2, L1.3 of the first neural network NN.1. Alternatively, the first part P1 can comprise other layers L1.1, . . . , L1.4 of the first neural network NN.1, in particular, consecutive layers L1.1, . . . , L1.4 of the first neural network NN.1. Furthermore, the first neural network NN.1 comprises a preprocessing part PP, which consists of the input layer L1.1 of the first neural network NN.1 and the first hidden layer L1.2 of the first neural network NN.1. In particular, the preprocessing part PP comprises consecutive layers L1.1, . . . , L1.4 of the first neural network NN.1, and the last layer L1.2 of the preprocessing part PP equals the first layer L1.2 of the first part P1. However, the preprocessing part can also consist of other layers L1.1, . . . , L1.4 of the first neural network NN.1.

FIG. 2 displays an embodiment of a second neural network NN.2. The second neural network NN.2 takes second input data INPD.2 and is configured to map the second input data INPD.2 to second output data OUTD.2.

The second neural network NN.2 consists of four layers L2.1, . . . , L2.4 (an input layer L2.1, an output layer L2.4 and two hidden layers L2.2, L2.3). In this embodiment, the second neural network NN.2 comprises the same number of layers as the first neural network NN.1, however the second neural network NN.2 could also comprise more or less layers than the first neural network NN.1. In this embodiment, the four layers L2.1, . . . , L2.4 of the second neural network NN.2 are consecutive layers. Each of the layers L2.1, . . . , L2.4 comprises at least one node. Nodes of consecutive layers L2.1, . . . , L2.4 are connected by edges, and there is a weight (being a real number, preferably between −1 and 1) assigned to each of the edges. In this embodiment, between every pair of nodes in two consecutive layers there is an edge between these nodes (fully connected layers). Alternatively, it is also possible that there are only edges between selected pairs of nodes.

In this embodiment, the first input data INPD.1 and the second input data INPD.2 have the same structure, both the first input data INPD.1 and the second input data INPD.2 are four-dimensional vectors. In particular, the input layer L1.1 of the first neural network NN.1 and the input layer L2.1 of the second neural network NN.2 comprise the same number of nodes.

In the following, let yi(k) denote the value of the i-th node in the k-th layer L2.1, . . . , L2.4. In this notation, the second input data INPD.2 corresponds to the values yi(1), and the second output data OUTD.2 corresponds to the values yi(4). Values of a layer yj(k+1) are calculated based on the values of the previous layer yi(k) by yj(k+1)=f(k+1) (ΣjWij(k,k+1) xi(k)), wherein Wij(k,k+1) denotes the weight of the edge between node i in the k-th layer and node j in the (k+1)-th layer, and wherein f(k+1): [symbol] → [symbol] or f(k+1): [symbol] →[0, 1] is an activation function (e.g., sigmoid, tanh, ReLU or SoftMax function). The values of the weights can be structured as a matrix, and the values of the nodes can be structured as a vector, so that the calculation is equivalent to y(k+1)=f(k+1) (W(k,k+1) y(k)), wherein the activation function is applied component-wise to its argument.

In this embodiment, the second neural network NN.2 comprises a second part P2, which consists of the hidden layers L2.2, L2.3 of the second neural network NN.2. Alternatively, the second part P2 can comprise other layers L2.1, . . . , L2.4 of the second neural network NN.2, in particular, consecutive layers L2.1, . . . , L2.4 of the second neural network NN.2.

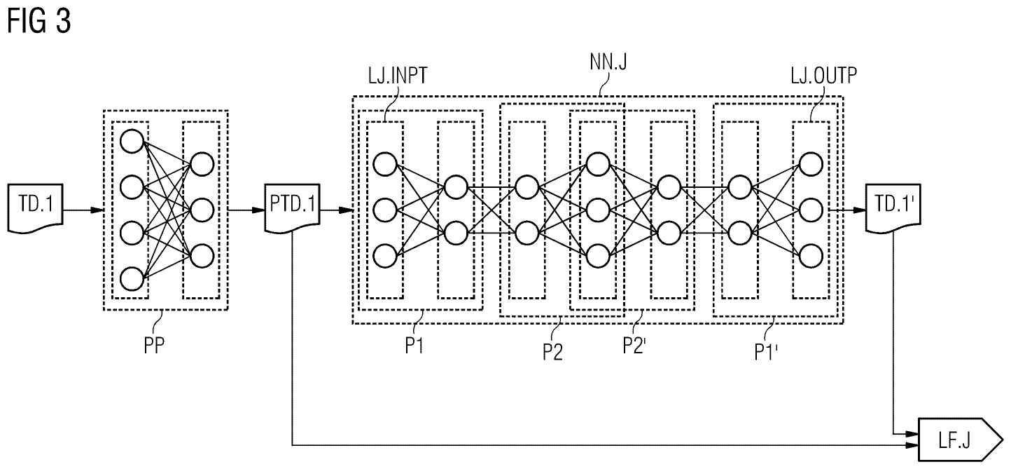

FIG. 3 displays an embodiment of a joint neural network NN.J. based on the first part P1 of the first neural network NN.1 as displayed in FIG. 1 and based on the second part P2 of the second neural network NN.2 as displayed in FIG. 2.

The joint neural network is constructed by concatenating the first part P1 and the second part P2. Furthermore, in this embodiment the joint neural network NN.J also comprises a mirrored first part P1′ and a mirrored second part P2′. For the mirrored parts, the transposed weight matrices are used instead of the original weight matrices.

The joint neural network NN.J comprises an input layer LJ.INPT and an output layer LJ.OUTP, wherein the input layer LJ.INPT and the output layer LJ.OUTP comprise the same number of nodes (in the displayed example, both the input layer LJ.INPT and the output layer LJ.OUTP comprise three nodes).

In this embodiment, there is no additional layer between the first part P1 and the second part P2 within the joint neural network NN.J. The joint model is constructed so that all nodes of the last layer of the first part P1 are connected to all nodes of the first layer of the second part P2 (fully-connected layer), and the corresponding weights are initialized randomly. Alternatively, it is possible to include additional layers between the first part P1 and the second part P2, the additional weights can also be initialized randomly.

In this embodiment, the joint neural network NN.J comprises the second part P2 and a mirrored second part P2′. The weights of the mirrored second part P2 are initialized so that for the mirrored second part P2′ the transposed weight matrix WT of the corresponding layers within the second part P2 is used. In this embodiment, the last layer of the second part P2 is equivalent to the first layer of the mirrored second part P2′. Alternatively, one could also use additional layers between the second part P2 and the mirrored second part P2′, the additional weights between the additional layers can be initialized randomly.

In this embodiment, there is no additional layer between the mirrored second part P2′ and the mirrored first part P1 within the joint neural network NN.J. The joint model is constructed so that all nodes of the last layer of the mirrored second part P2′ are connected to all nodes of the first layer of the mirrored first part P1′ (fully-connected layer), and the corresponding weights are initialized randomly. Alternatively, it is possible to include additional layers between the mirrored second part P2′ and the mirrored first part P1′, the additional weights can also be initialized randomly.

For adapting the weights of the joint neural network NN.J in training, first training data TD.1 is preprocessed by the preprocessing part PP of the first neural network NN.1, so that preprocessed training data PTD.1 is generated. The preprocessed training data PTD.1 is used as the input data for the joint neural network NN.J, so that output data TD.1′ is generated. The preprocessed training data PTD.1 and the output data TD.1′ have the same structure, for example, they can be vectors of the same dimension. The weights of the joint neural network NN.J are adapted based on a lost function LF.J, wherein the loss function LF.J is based on a comparison of the preprocessed training data PTD.1 and the output data TD.1. In this embodiment, the loss function is based on the residual sum of squares of the preprocessed training data PTD.1 and the output data TD.1. The adaption of the weights is based on the backpropagation algorithm.

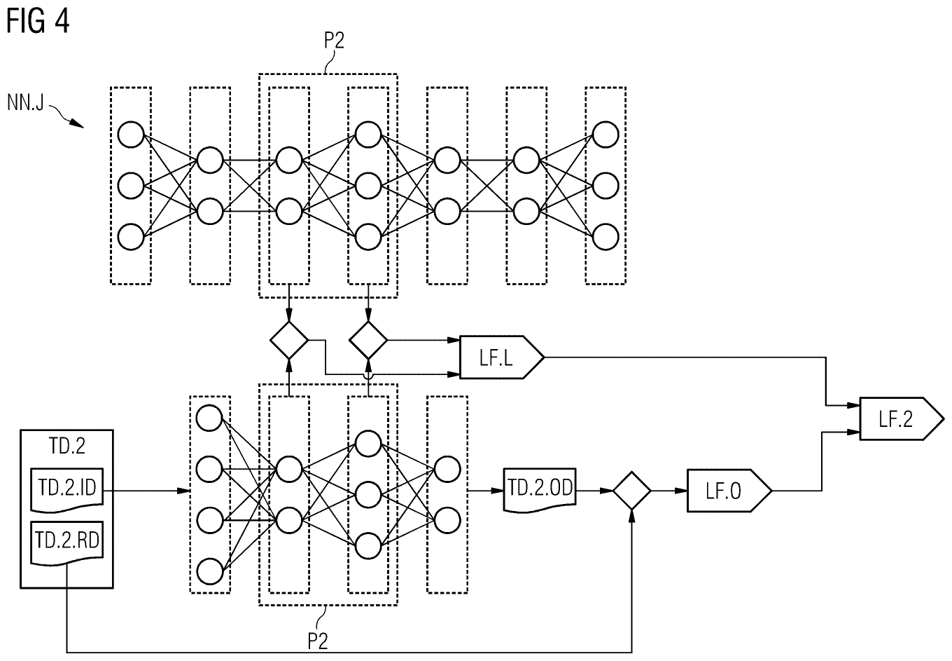

FIG. 4 displays the training of the second neural network NN.2 based on the pre-trained joint neural network NN.J. The second neural network NN.2 has the same structure as displayed in FIG. 2, and the joint neural network NN.J has the same structure as displayed in FIG. 3.

Before training the second neural network NN.2, the weights of the second part P2 within the second neural network NN.2 are copied from the respective part of the joint neural network NN.J, or initialized randomly.

Training of the second neural network NN.2 is based on second training data TD.2. In this embodiment, the second training data TD.2 comprises pairs of training input data TD.2.ID and training reference data TD.2.RD. Within the training process, the training input data TD.2.ID is used as input for the second neural network NN.2 in order to create training output data TD.2.OD. For adapting the weights of the second neural network NN.2 using the backpropagation algorithm a second loss function LF.2 is used.

In this embodiment, the second loss function LF.2 comprises an output loss function LF.O and a layer loss function LF.L. The output loss function LF.O is based on a comparison of the training reference data TD.2.RD and the training output data TD.2.OD. The layer loss function LF.L is based on a comparison of the values of the layers of the second part P2 within the second neural network NN.2 and the corresponding layers of the second part P2 within the joint neural network NN.J. In particular, the following term can be used for the second loss function LF.2:

$$L 2 ∝ LO ( tR , tO ) + α \cdot Σ k ∈ P 2 LL ( y ( k ) , z ( k ) )$$

wherein LO denotes the output loss function LF.O, tR denotes the training reference data TD.2.RD, to denotes the training output data TD.2.OD, α is a weighting factor, the sum runs over all layers in the second part P2, LL denotes the layer loss function LF.L, y(k) denotes the values of the k-th layer within the second neural network NN.2, and z(k) denotes the values of the corresponding layer within the joint neural network NN.J.

In this embodiment, the output loss function LF.O is based on a loss function is a residual sum of squares:

$$LO ( tR , tO ) ∝ Σ i ( tR , i - tO , i ) 2.$$

Instead of a residual sum of squares it is also possible to use other loss functions that measure the difference between the training reference data TD.2.RD and the training output data TD.2.OD.

In this embodiment, the layer loss function LF.L is a cosine similarity of the vector representing values of the respective layers:

$$LL ( y ( k ) , z ( k ) ) ∝ y ( k ) ∘ z ( k ) / \vert y ( k ) \vert \cdot \vert z ( k ) \vert$$

In this formula, o denotes the scalar product of two vectors, and |⋅| denotes the length of a vector. Alternatively, other loss functions can be used. For example, one can use a L1 loss function:

$$LL ( y ( k ) , z ( k ) ) ∝ Σ i \vert yi ( k ) - zi ( k ) \vert$$

Alternatively, one can use a L2 loss function (corresponding to the residual sum of squares):

$$LL ( y ( k ) , z ( k ) ) ∝ Σ i ( yi ( k ) - zi ( k ) ) 2$$

Alternatively, one can also use a combination of these loss functions and/or other similar loss functions.

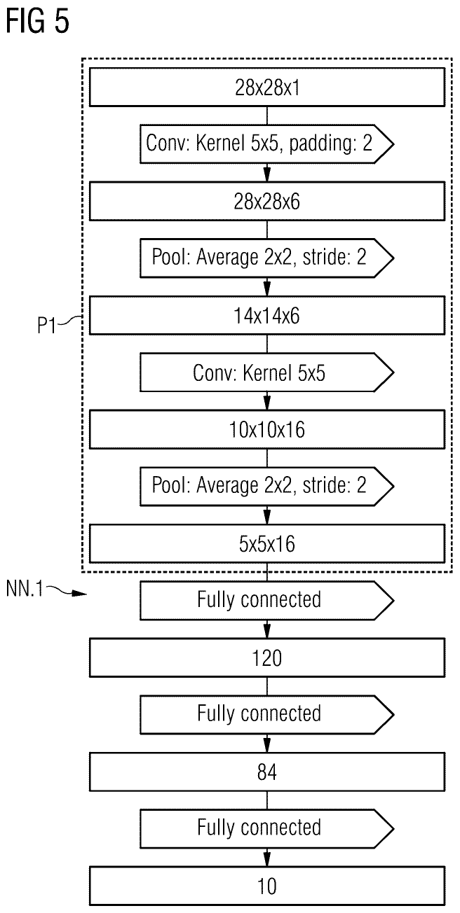

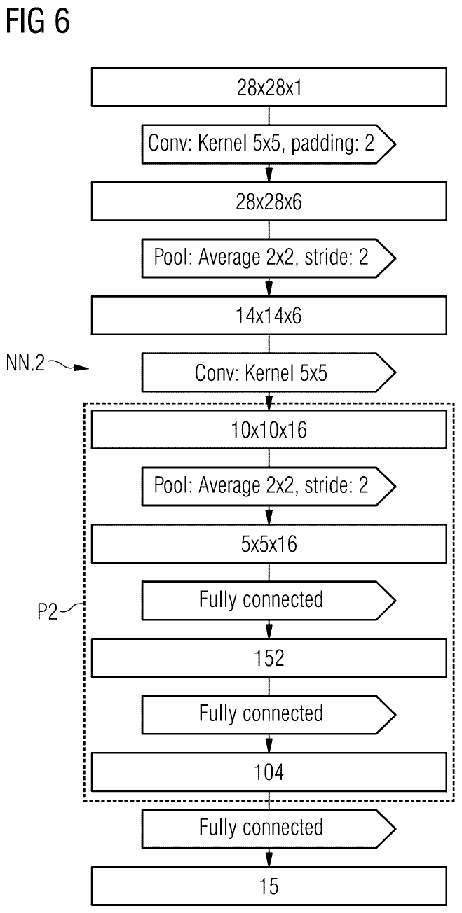

FIG. 5 displays a second embodiment of a first neural network NN.1 and FIG. 6 displays a second embodiment of a second neural network NN.2.

This embodiment of the first neural network NN.1 corresponds to a variant of the LeNet for processing 28×28 pixel image patches in order classify the input image into ten classes. The LeNet structure is disclosed, e.g., in the paper Y. Lecun et al. “Gradient-based learning applied to document recognition” (1998), Proc. IEEE. 86 (11) 2278-2324, doi: 10.1109/5.726791. The first neural network NN.1 comprises 8 consecutive layers (an input layer, an output layer and 6 hidden layers), indicated as rectangles in FIG. 5. The first and the second layer as well as the third and the fourth layer are connected by edges (indicated by five-sided arrows in FIG. 5) forming a convolution operation with kernel size 5×5 and padding 2 or no padding. The second and the third layer as well as the fourth and the fifth layer are connected by edges forming an average 22 pooling operation with stride 2. All other layers are fully connected.

In this embodiment, the second neural network NN.2 corresponds to another variant of the LeNet for processing 28×28 pixel images patches. In contrast to the first neural network NN.1, the second neural network NN.2 classifies into 15 different classes (for example, the second neural network NN.2 can recognize the 10 classes of the first neural network NN.1 and additional 5 classes not recognized by the first neural network NN.1). The structure of the second neural network NN.2 is similar to the structure of the first neural network NN.1, however, the size of the last three layers of the second neural network NN.2 is increased compared to the first neural network NN.1.

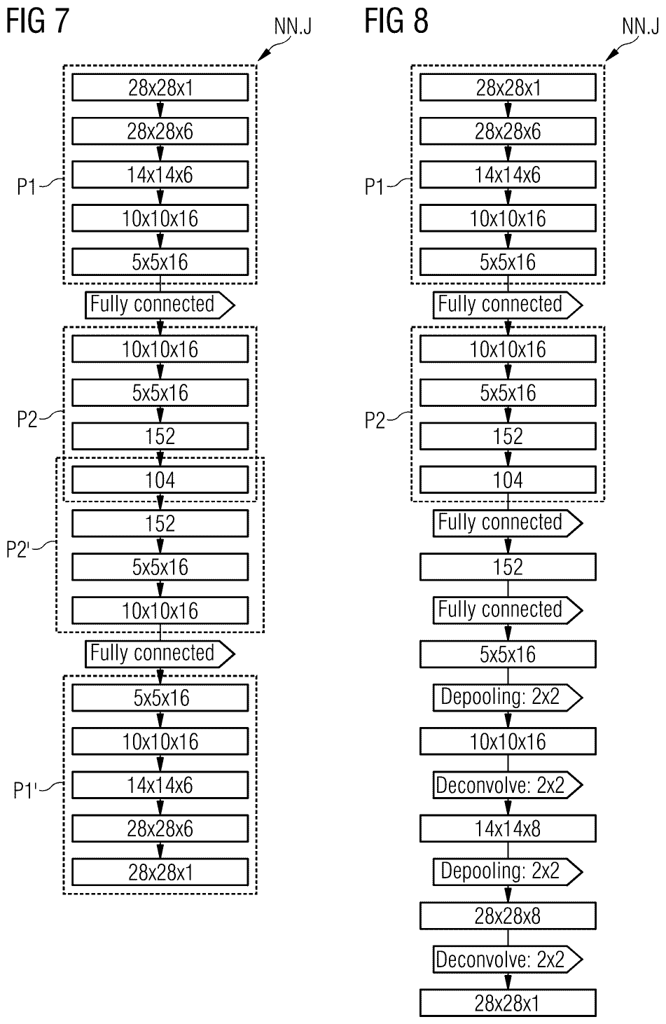

FIG. 7 displays a second embodiment of a joint neural network NN.J that is based on the first neural network NN.1 displayed in FIG. 5 and the second neural network NN.2 displayed in FIG. 6.

In this embodiment, the joint neural network NN.J comprises the first part P1 of the first neural network NN.J, the second part P2 of the second neural network NN.2, a mirrored second part P2 and a mirrored first part P1. The first part P1 and the second part P2, as well as the mirrored second part P2 and the mirrored first part P1 are connected via fully connected edges. However, it would also be possible to use less connections. Due to the fact that the first layer of the first neural network NN.1 and the first layer of the joint neural network NN.J are corresponding layers, training data suitable for the first neural network NN.1 can directly be used for the joint neural network NN.J without preprocessing.

The training of the joint neural network NN.J in this embodiment can be executed analogous to the embodiment displayed in FIG. 3, however in this embodiment the preprocessed training data PTD.1 equals the first training data TD.1. The training of the second neural network NN.J based on the pre-trained joint neural network NN.J in this embodiment can be executed analogous to the embodiment displayed in FIG. 4.

FIG. 8 displays a third embodiment of a joint neural network NN.J that is based on the first neural network NN.1 displayed in FIG. 5 and the second neural network NN.2 displayed in FIG. 6.

In this embodiment, the joint neural network NN.J comprises the first part P1 of the first neural network NN.J and the second part P2 of the second neural network NN.2. The first part P1 and the second part P2 are connected via fully connected edges. However, it would also be possible to use less connections. Due to the fact that the first layer of the first neural network NN.1 and the first layer of the joint neural network NN.J are corresponding layers, training data suitable for the first neural network NN.1 can directly be used for the joint neural network NN.J without preprocessing.

In this embodiment, the joint neural network NN.J comprises additional layers that are neither contained in the first neural network NN.1 nor in the second neural network NN.2. In particular, the joint neural network NN.J comprises depooling and deconvolutional layers for upsampling, so that the input layer and the output layer have the same size and structure.

The training of the joint neural network NN.J in this embodiment can be executed analogous to the embodiment displayed in FIG. 3, however in this embodiment the preprocessed training data PTD.1 equals the first training data TD.1. The training of the second neural network NN.J based on the pre-trained joint neural network NN.J in this embodiment can be executed analogous to the embodiment displayed in FIG. 4.

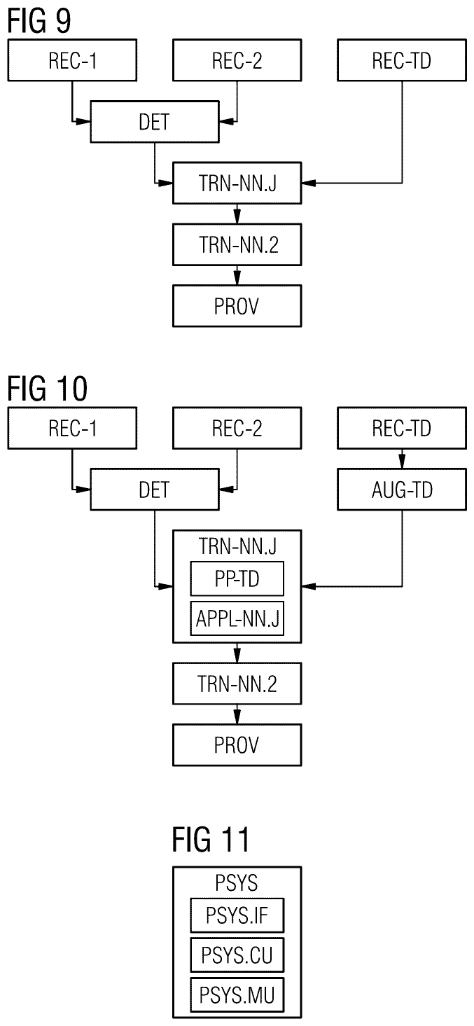

FIG. 9 displays a flowchart of a first embodiment of a method for providing a trained second neural network NN.2.

According to this embodiment, the method comprises the step of receiving REC-1 a first neural network NN.1 trained to map first input data INPD-1 to first output data OUTD-1. In this embodiment, the first neural network NN.1 has the structure as described with respect to FIG. 1, alternatively other first neural networks NN.1 can be used. The method furthermore comprises the step of receiving the second neural network NN.2 configured to map second input data INPD-2 to second output data OUTD-2. In this embodiment, the second neural network NN.2 has the structure as described with respect to FIG. 2, alternatively other second neural networks NN.2 can be used.

The second input data INPD-2 has the same structure as the first input data INPD-1. This implies that the second neural network NN.2 can process the same input data as the first neural network NN.1. It is possible that (compared with the first neural network NN.1) the second neural network NN.2 can process additional input data.

The method furthermore comprises the step of determining DET a joint neural network NN.J, wherein the joint neural network comprises a first part P1 of the first neural network NN.1 and a second part P2 of the second neural network NN.2. In this embodiment, the joint neural network NN.J has the structure as described with respect to FIG. 3, alternatively other joint neural networks NN.J can be used.

In this embodiment of the method the second part P2 comprises a plurality of consecutive second layers L2.1, . . . , L2.M of the second neural network NN.2. Alternatively, the second part P2 could comprise only one layer of the second layers L2.1, . . . , L2.M of the second neural network NN.2, or the second part P2 could comprise a plurality of non-consecutive second layers L2.1, . . . , L2.M of the second neural network NN.2.

In this embodiment of the method the first part P1 comprises a plurality of consecutive first layers L1.1, . . . , L1.N of the first neural network NN.1. Alternatively, the first part P1 could comprise only one layer of the first layers L1.1, . . . , L1.N of the first neural network NN.1, or the first part P1 could comprise a plurality of non-consecutive first layers L1.1, . . . , L1.N of the first neural network NN.1.

In this embodiment of the method the joint neural network NN.J comprises a mirrored second part P2′ being a mirrored version of the second part P2. Furthermore, the last layer of the second part P2 and the first layer of the mirrored second part P2′ are identical. Furthermore, the joint neural network NN.J comprises a mirrored first part P1′ being a mirrored version of the first part P1. In the joint neural network NN.J the first part P1 is arranged before the second part P2, and the mirrored first part P1′ is arranged after the mirrored second part P2′.

The method furthermore comprises the step of receiving REC-TD first training data TD.1 and second training data TD.2. In this embodiment, the second training data TD.2 comprises training input data TD.2.ID and associated training reference data TD.2.RD, preferably the second training data TD.2 comprises a plurality of pairs of training input data TD.2.ID and associated training reference data TD.2.RD. In particular, the training input data TD.2.ID has the same structure as the second input data INPD-2.

The method furthermore comprises the step of training TRN-NN.J the joint neural network NN.J based on the first training data TD.1. In this specific embodiment, the joint neural network NN.J comprises an input layer LJ.INPT and an output layer LJ.OUTP, and the input layer LJ.INPT of the joint neural network NN.J and the output layer LJ.OUTP of the joint neural network NN.J have equal size. Furthermore, training TRN-NN.J the joint neural network NN.J is based on the difference of input data of the joint neural network NN.J and the output of the joint neural network NN.J when applied to the input data, wherein the input data is based on the first training data TD.1. However, it is also possible to use other methods of training for the joint neural network NN.J based on the first training data TD.1.

The method furthermore comprises the step of training TRN-NN.2 the second neural network NN.2 based on the second training data TD.2 and a second loss function LF.2. The second loss function LF.2 comprises a layer loss function LF.L based on a comparison of values of a second layer L2.1, . . . , L2.M of the second part P2 in the second neural network NN.2 and values of a corresponding layer in the trained joint neural network NN.J. The step of training TRN-NN.2 the second neural network NN-2 is explained in further detail with respect to FIG. 4.

The method furthermore comprises providing PROV the second neural network NN.2. Providing PROV the second neural network NN.2 can comprise at least one of storing, transmitting and displaying the second neural network NN.2.

In this embodiment, the steps of receiving REC-1 the first neural network NN.1 and receiving REC-2 the second neural network NN.2, as well as the step of receiving REC-TD the first training data TD.1 and second training data TD.2 are executed by an interface PSYS. IF of providing system PSYS. Furthermore, the steps of determining DET the joint neural network NN.J as well as training TRN-NN.J, TRN-NN.2 the joint neural network NN.J and the second neural network NN.2 are executed by a computation unit PSYS.CU of the providing system PSYS. Furthermore, the step of providing PROV the second neural network NN.2 is executed by the interface PSYS. IF of the providing system PSYS.

FIG. 10 displays a flowchart of a second embodiment of a method for providing a trained second neural network NN.2. This embodiment comprises all steps of the first embodiment of the method for providing a trained second neural network NN.2 described with respect to FIG. 9. These steps may have any of the advantageous further embodiments already disclosed with respect to FIG. 9.

The second embodiment furthermore comprises the step of augmenting AUG-TD the first training data TD.1 and/or the second training data TD.2. Augmenting AUG-TD the first training data TD.1 and/or the second training data TD.2 includes techniques such as perturbation, rotation, scaling, flipping, cropping, or any other type of transformation known in the art.

In the second embodiment, the step of training TRN-NN.J the joint neural network NN.J furthermore comprises the steps of preprocessing PP-TD the first training data TD.1 with a preprocessing part PP of the first neural network NN.1 and applying APPL-NN.J the joint neural network NN.J to input data comprising the preprocessed first training data PTD.1. In this embodiment, the preprocessing part PP and the first part P1 consist of consecutive first layers L1.1, . . . , L1.N of the first neural network NN.1, and the last layer of the preprocessing part PP is the first layer of the first part P1. Alternatively, one can use other ways of preprocessing the first training data TD.1 and/or other structures of preprocessing parts PP of the first neural network NN.1.

FIG. 11 displays an embodiment of a providing system PSYS according to an embodiment of the present invention. The providing system PSYS is configured for executing a method for providing a trained second neural network NN.2 according to embodiments of the present invention.

The providing system PSYS can be or comprise a (personal) computer, a workstation, a virtual machine running on host hardware, a microcontroller, or an integrated circuit. As an alternative, the providing system PSYS can be a real or a virtual group of computers (the technical term for a real group of computers is “cluster”, the technical term for a virtual group of computers is “cloud”).

The providing system PSYS can comprise an interface PSYS.IF, a computation unit PSYS.CU and a memory unit PSYS.MU. An interface PSYS. IF can be a hardware interface or as a software interface (e.g. PCIBus, USB or Firewire). A computation unit PSYS.CU can comprise hardware elements and software elements, for example a microprocessor, a CPU (acronym for “central processing unit”), a GPU (acronym for “graphical processing unit”), a field programmable gate array (an acronym is “FPGA”) or an ASIC (acronym for “application-specific integrated circuit”). A computation unit PSYS. CU can be configured for multithreading, i.e., the computation unit can host different computation processes at the same time, executing the either in parallel or switching between active and passive computation processes. Each of the interface PSYS.IF, the computation unit PSYS.CU and the memory unit PSYS.MU can comprise several subunits which are configured to executed different tasks and/or which are spatially separated.

The providing system PSYS can be connected to a database via a network NET. In particular, the database can store the first training data TD.1 and/or the second training data TD.2. The network can be realized as a LAN (acronym for “local area network”), in particular a WiFi network, or any other local connection. Alternatively, the network can be the internet. In particular, the network could be realized as a VPN (acronym for “virtual private network”). Alternatively, the database can also be integrated into the providing system PSYS, e.g., the database could be stored within the memory unit PSYS.MU of the providing system PSYS. In this case the database is connected with an internal connection.

Wherever not already described explicitly, individual embodiments, or their individual aspects and features, can be combined or exchanged with one another without limiting or widening the scope of the described invention, whenever such a combination or exchange is meaningful and in the sense of this invention. Advantages which are described with respect to one embodiment of the present invention are, wherever applicable, also advantageous of other embodiments of the present invention.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been shown and described with respect to certain example embodiments, equivalents and modifications will occur to others skilled in the art upon the reading and understanding of the specification. The present invention includes all such equivalents and modifications and is limited only by the scope of the appended claims.

What is claimed is:

1. A computer-implemented method for providing a trained second neural network, the method comprising:
receiving a first neural network trained to map first input data to first output data;
receiving a second neural network configured to map second input data to second output data, wherein the second input data has a same structure as the first input data;
determining a joint neural network including a first part of the first neural network and a second part of the second neural network;
receiving first training data and second training data;
training the joint neural network based on the first training data;
training the second neural network based on the second training data and a second loss function, wherein the second loss function includes a layer loss function based on a comparison of values of a second layer of the second part in the second neural network and values of a corresponding layer in the trained joint neural network; and
providing the second neural network.

2. The method according to claim 1, wherein the second part comprises a plurality of consecutive second layers of the second neural network.

3. The method according to claim 2, wherein
the joint neural network comprises a mirrored second part, which is a mirrored version of the second part, and
a last layer of the second part and a first layer of the mirrored second part are identical.

4. The method according to claim 3, wherein
the first part comprises a plurality of consecutive first layers of the first neural network,
the joint neural network comprises a mirrored first part, which is a mirrored version of the first part, and
in the joint neural network, the first part is arranged before the second part and the mirrored first part is arranged after the mirrored second part.

5. The method according to claim 1, wherein the layer loss function is based on at least one of cosine similarity, L1 loss or L2 loss of the second layer of the second part in the second neural network and the corresponding layer in the trained joint neural network.

6. The method according to claim 1, wherein
the second training data comprises training input data and associated training reference data, and
the second loss function includes an output loss function based on a comparison of a result of applying the second neural network to the training input data and the associated training reference data.

7. The method according to claim 1, wherein
the joint neural network comprises an input layer and an output layer, and
the input layer of the joint neural network and the output layer of the joint neural network have equal size.

8. The method according to claim 7, wherein
training the joint neural network is based on a difference of input data of the joint neural network and an output of the joint neural network when applied to the input data, and
the input data is based on the first training data.

9. The method according to claim 1, wherein training the joint neural network comprises:
preprocessing the first training data with a preprocessing part of the first neural network, and
applying the joint neural network to input data including the preprocessed first training data.

10. The method according to claim 9, wherein
the preprocessing part and the first part include consecutive first layers of the first neural network, and
a last layer of the preprocessing part is a first layer of the first part.

11. The method according to claim 1, further comprising:
augmenting at least one of the first training data or the second training data.

12. A computer-implemented method comprising:
using a second neural network provided by the computer-implemented method of claim 1 for at least one of
controlling a medical imaging apparatus,
controlling a laboratory apparatus,
processing a medical image of a patient,
digital audio enhancement,
image enhancement,
video enhancement,
digital audio analysis,
image analysis,
video analysis,
encrypting electronic communications,
decrypting electronic communications,
signing electronic communications,
speech recognition,
providing a medical diagnosis by an automated system processing physiological measurements,
processing a medical image of a patient for segmentation segment, or
classifying a structure within the medical image.

13. A providing system comprising an apparatus for carrying out the method of claim 1.

14. A non-transitory computer program product comprising instructions that, when executed by a computer, cause the computer to carry out the method of claim 1.

15. A non-transitory computer-readable storage medium comprising instructions that, when executed by a computer, cause the computer to carry out the method of claim 1.

16. The method according to claim 3, wherein the layer loss function is based on at least one of cosine similarity, L1 loss or L2 loss of the second layer of the second part in the second neural network and the corresponding layer in the trained joint neural network.

17. The method according to claim 3, wherein
the second training data comprises training input data and associated training reference data, and
the second loss function includes an output loss function based on a comparison of a result of applying the second neural network to the training input data and the associated training reference data.

18. The method according to claim 4, wherein the layer loss function is based on at least one of cosine similarity, L1 loss or L2 loss of the second layer of the second part in the second neural network and the corresponding layer in the trained joint neural network.

19. The method according to claim 4, wherein
the second training data comprises training input data and associated training reference data, and
the second loss function includes an output loss function based on a comparison of a result of applying the second neural network to the training input data and the associated training reference data.

20. The method according to claim 4, wherein training the joint neural network comprises:
preprocessing the first training data with a preprocessing part of the first neural network, and
applying the joint neural network to input data including the preprocessed first training data.
